(19) United States
(12) Patent Application Publication
(10) Pub. No.: US 2025/0337195 A1
(43) Pub. Date: Oct. 30, 2025

(54) GANGED COAXIAL CONNECTOR ASSEMBLY WITH DUAL-STOP LATCH

(71) Applicant: OUTDOOR WIRELESS NETWORKS LLC, Richardson, TX (US)

(72) Inventors: MuLan Huang, Suzhou (CN); ZhaoHui Liu, Suzhou (CN); Lan Dong, Suzhou (CN); Yuanyao Zhou, Suzhou (CN)

(21) Appl. No.: 19/093,468

(22) Filed: Mar. 28, 2025

Related U.S. Application Data
(60) Provisional application No. 63/640,338, filed on Apr. 30, 2024.

(51) Int. Cl. H01R 13/629; H01R 24/40

(52) U.S. Cl. CPC H01R 13/62933; H01R 24/40

(57) ABSTRACT

A mated connector assembly includes a first connector assembly and a second connector assembly. The first connector assembly includes a plurality of first coaxial connectors mounted on a substrate, each of the first coaxial connectors connected with a respective first coaxial cable, the first connector assembly further comprising a post extending from the mounting substrate, which first and second projections extend laterally from the post. The second connector assembly includes a plurality of second coaxial connectors and a shell, each of the second coaxial connectors connected with a respective second coaxial cable, the shell defining a plurality of electrically isolated second cavities, each of the second coaxial connectors being located in a respective second cavity and mounted therein to float radially and axially relative to each of the other second coaxial connectors. The second connector assembly includes a latch pivotable between an unlatched position and a latched position, the latch including a cross-member, side walls extending from the cross-member, and a latching member extending from each of the side walls, wherein first and second recesses are present in the latching member. In a mated condition each of the first coaxial connectors is mated with a respective second coaxial connector. When the first and second connector assemblies are secured in the mated condition by the latch when the latch is in the latched position, the latch engages the projection such that the first and second projections are received in the first and second recesses.

### RELATED APPLICATION

The present application claims priority from and the benefit of U.S. Provisional Patent Application No. 63/640,338, filed Apr. 30, 2024, the disclosure of which is hereby incorporated herein by reference in full.

### FIELD OF THE INVENTION

The present invention relates generally to electrical cable connectors and, more particularly, to ganged connector assemblies.

### BACKGROUND

Coaxial cables are commonly utilized in RF communications systems. Coaxial cable connectors may be applied to terminate coaxial cables, for example, in communication systems requiring a high level of precision and reliability.

Connector interfaces provide a connect/disconnect functionality between a cable terminated with a connector bearing the desired connector interface and a corresponding connector with a mating connector interface mounted on an apparatus or a further cable. Some coaxial connector interfaces utilize a retainer (often provided as a threaded coupling nut) that draws the connector interface pair into secure electro-mechanical engagement as the coupling nut, rotatably retained upon one connector, is threaded upon the other connector.

Alternatively, connection interfaces may be also provided with a blind mate characteristic to enable push-on interconnection, wherein physical access to the connector bodies is restricted and/or the interconnected portions are linked in a manner where precise alignment is difficult or not cost-effective (such as the connection between an antenna and a transceiver that are coupled together via a rail system or the like). To accommodate misalignment, a blind mate connector may be provided with lateral and/or longitudinal spring action, or “float,” to accommodate a limited degree of insertion misalignment. Blind mated connectors may be particularly suitable for use in “ganged” connector arrangements, in which multiple connectors (for example, four connectors) are attached to each other and are mated to mating connectors simultaneously.

Examples of ganged coaxial connectors is discussed in U.S. Patent Publication No. 2019/0312394 to Paynter, the disclosure of which is hereby incorporated herein by reference in full. This publication identifies solutions for two different issues that can arise with ganged blind mate connectors: “float” and secure interconnection. Ganged connectors are shown therein with a common shell. Each individual “male” connector is sized to be able to “float” axially, angularly and radially relative to the shell. Also, each individual “male” connector engages a respective helical spring that also engages the shell. Although each connector can move relative to the shell to adjust during mating, compression in the spring can provide sufficient force that, once the male connector is mated, the male connector is maintained in position relative to the shell. The ganged male connectors are secured to the mating “female” connectors via a pivoting latch that captures a pin on gang of male connectors.

It may be desirable to develop additional concepts and solutions for ganged coaxial connectors.

### SUMMARY

As a first aspect, embodiments of the invention are directed to a mated connector assembly. The mated connector assembly comprises a first connector assembly and a second connector assembly. The first connector assembly comprises a plurality of first coaxial connectors mounted on a substrate, each of the first coaxial connectors connected with a respective first coaxial cable, the first connector assembly further comprising a post extending from the mounting substrate, which first and second projections extend laterally from the post. The second connector assembly comprises a plurality of second coaxial connectors and a shell, each of the second coaxial connectors connected with a respective second coaxial cable, the shell defining a plurality of electrically isolated second cavities, each of the second coaxial connectors being located in a respective second cavity and mounted therein to float radially and axially relative to each of the other second coaxial connectors. The second connector assembly includes a latch pivotable between an unlatched position and a latched position, the latch including a cross-member, side walls extending from the cross-member, and a latching member extending from each of the side walls, wherein first and second recesses are present in the latching member. In a mated condition each of the first coaxial connectors is mated with a respective second coaxial connector. When the first and second connector assemblies are secured in the mated condition by the latch when the latch is in the latched position, the latch engages the projection such that the first and second projections are received in the first and second recesses.

As a second aspect, embodiments of the invention are directed to a connector assembly comprising: a plurality of coaxial connectors mounted on a substrate; a plurality of coaxial cables, each of the coaxial connectors connected with a respective coaxial cable; and a post extending from the mounting substrate, wherein first and second projections extend laterally from the post.

As a third aspect, embodiments of the invention are directed to a coaxial connector assembly comprising: a plurality of coaxial connectors; a plurality of coaxial cable, each connected with a respective coaxial connector; a shell defining a plurality of electrically isolated cavities, each of the coaxial connectors being located in a respective second cavity and mounted therein to float radially and axially relative to each of the other coaxial connectors; and a latch pivotable between an unlatched position and a latched position, the latch including a cross-member, side walls extending from the cross-member, and a latching member extending from each of the side walls, wherein first and second recesses are present in the latching member.

### BRIEF DESCRIPTION OF THE FIGURES

FIG. 1 is a perspective view of a prior assembly of mated ganged connectors.

FIG. 2 is an end perspective view of the assembly of FIG. 1.

FIG. 3 is a side view of the assembly of FIG. 1 mated with a mating assembly and the latch engaged to secure the assemblies together.

FIG. 4 is a section view of the assembly of FIG. 1 showing the springs employed to provide the individual connectors the ability to ‘float” relative to the housing.

FIG. 5 is a section view of an alternative version of the assembly of FIG. 1 showing springs that provide the ability of the connectors to float.

FIG. 6 is a side view of a ganged connector assembly according to embodiments of the invention.

FIG. 7 is a side view of a mating ganged connector assembly to be mated with the assembly of FIG. 6.

FIG. 8 is a perspective view of the latch of the ganged connector assembly of FIG. 6.

FIG. 9 is a perspective view of the posts and capture projections of the ganged connector of FIG. 7.

FIGS. 10A and 10B are side views showing unmated (FIG. 10A) and mated (FIG. 10B) assemblies of FIGS. 6 and 7.

FIGS. 11A and 11B are side views showing unmated (FIG. 11A) and mated (FIG. 11B) assemblies, wherein an assembly of FIG. 7 is mated with a prior ganged connector such as that of FIG. 3.

FIGS. 12A and 12B are side views showing unmated (FIG. 12A) and mated (FIG. 12B) assemblies, wherein an assembly of FIG. 6 is mated with a prior ganged connector such as that of FIG. 3.

FIG. 13 is a perspective view of the posts and capture projections of a ganged connector according to alternative embodiments of the invention.

### DETAILED DESCRIPTION

The present invention is described with reference to the accompanying drawings, in which certain embodiments of the invention are shown. This invention may, however, be embodied in many different forms and should not be construed as limited to the embodiments that are pictured and described herein; rather, these embodiments are provided so that this disclosure will be thorough and complete, and will fully convey the scope of the invention to those skilled in the art. It will also be appreciated that the embodiments disclosed herein can be combined in any way and/or combination to provide many additional embodiments.

Unless otherwise defined, all technical and scientific terms that are used in this disclosure have the same meaning as commonly understood by one of ordinary skill in the art to which this invention belongs. The terminology used in the below description is for the purpose of describing particular embodiments only and is not intended to be limiting of the invention. As used in this disclosure, the singular forms “a”, “an” and “the” are intended to include the plural forms as well, unless the context clearly indicates otherwise. It will also be understood that when an element (e.g., a device, circuit, etc.) is referred to as being “connected” or “coupled” to another element, it can be directly connected or coupled to the other element or intervening elements may be present. In contrast, when an element is referred to as being “directly connected” or “directly coupled” to another element, there are no intervening elements present.

As noted above, an issue that can arise with ganged connector assemblies is the alignment of individual mating connectors. Proper mating of the individual “male” connectors with the individual “female” connectors is needed to ensure that sound electrical contact is made. Quality of electrical contact can become more vital at high performance levels, as poor or inconsistent contact can produce unpredictable passive intermodulation (PIM) performance. PIM is an undesirable effect that can manifest itself in poor connections. As such, it is important in designing mating connectors that the contact/engagement between them be predictable.

A ganged connector assembly can introduce inconsistency in connector mating simply due to variables such as component tolerances. Thus, the ability of the mating connectors in a ganged assembly to float relative to the housing in which they are mounted, and to do so in a manner that maintains reliable and predictable contact between mating connectors, can be very desirable. Float can involve axial (i.e., in the direction of mating), radial (i.e., movement normal to the axial direction), and angular (“tilting” movement relative to the axial direction) components, so any float mechanisms or solution should permit movement in these three modes.

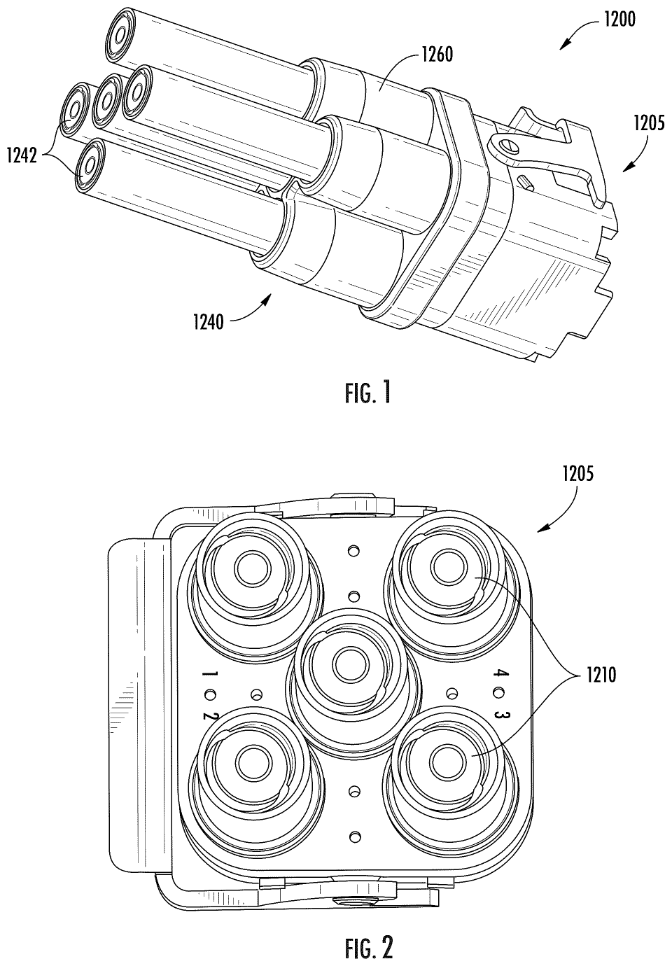

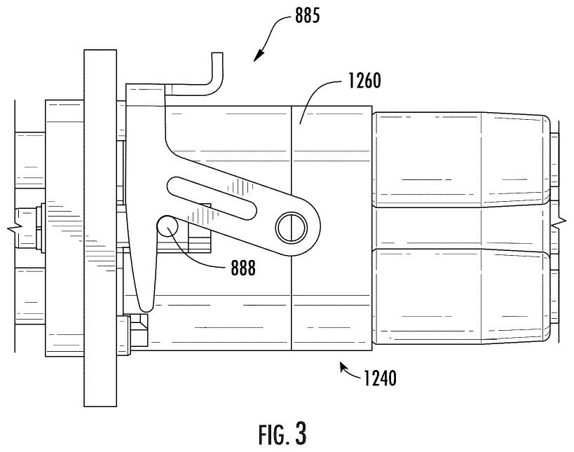

An example of an assembly with provisions for axial, radial and angular is shown in FIGS. 1-4. The paired assembly of connectors 1200 shown therein includes an equipment connector assembly 1205 with five connectors 1210 and a cable connector assembly 1240 with five connectors 1250 connected to five cables 1242. As shown in FIGS. 1-2 and 4, the connectors 1210 and 1250 are arranged in a cruciform pattern, with one of the connectors 1210, 1250 surrounded by four other connectors 1210, 1250 separated from each other by 90 degrees. As shown in FIG. 3, the assemblies 1205, 1240 can be secured with a latch 885 that is pivotally mounted to the assembly 1205 and engages a pin 888 on the assembly 1240.

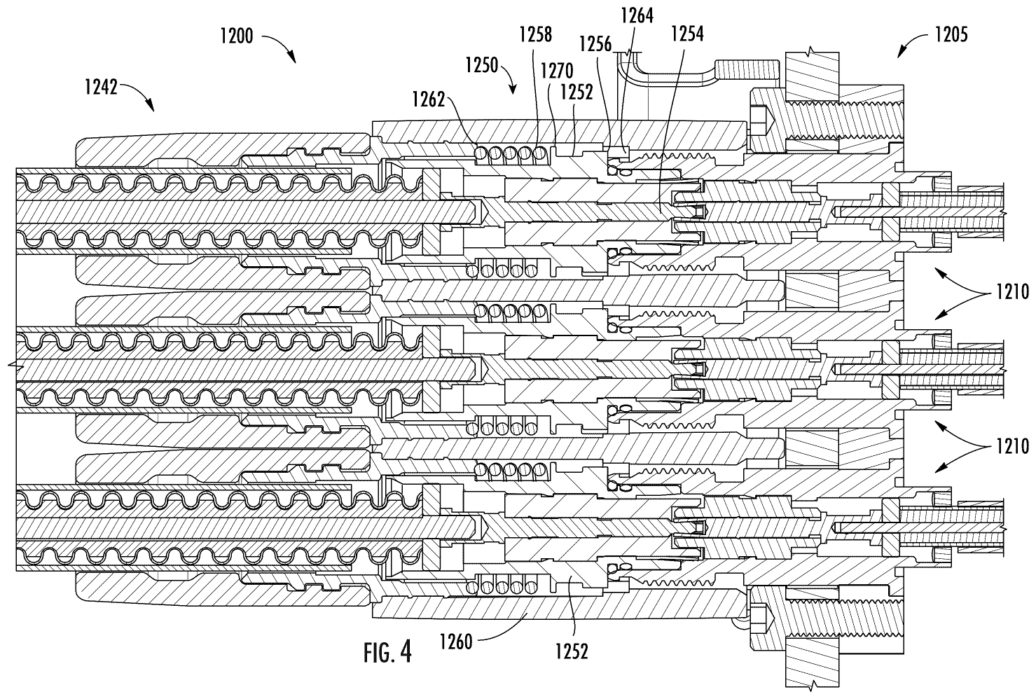

Referring now to FIG. 4, it can be seen that the connectors 1250 of the cable-connector assembly 1240 reside in a shell 1260. Each of the connectors 1250 includes an outer connector body 1252 and an inner contact 1254 that mate with, respectively, an outer connector body 1212 and an inner contact 1214 of a mating connector 1210 of the equipment connector assembly 1205. FIG. 4 also illustrates that each outer connector body 1252 is encircled by a helical spring 1258 that extends between a shoulder 1262 in the shell 1260 and a flange 1270 on the outer connector body 1252. The spring 1258 remains in compression. A shoulder 1256 of the outer connector body 1252 is positioned to engage a second shoulder 1264 of the shell 1260 and provide a forward limit on the forward movement of the outer connector body 1252. There is also space radially outward of the outer connector body 1252 between it and the shell 1260. Thus, the connector 1250 has the ability to float axially, radially, and angularly relative to the shell 1260, which can enable each of the connectors 1250 to adjust its position individually as needed to mate with the connectors 1210 of assembly 1205. The compressed spring 1258 provides sufficient force on the shell 1260 and the connector 1250 to maintain the connector 1250 in position relative to the shell 1260 once the connector 1250 has adjusted its position during mating.

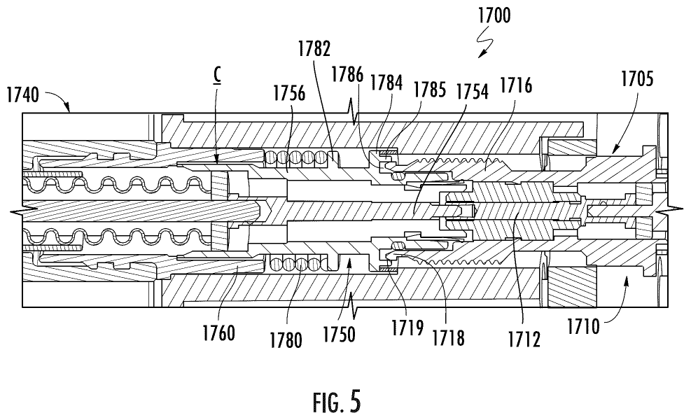

FIG. 5 illustrates another embodiment of a ganged connector assembly 1700. The assembly 1700 is similar to the assembly 1200, with an equipment connector assembly 1705 having connectors 1710 mating with a cable connector assembly 1740 with connectors 1750 in a shell 1760. Springs 1780 provide the capacity for axial and radial adjustment of the outer connector body 1756 relative to the shell 1760 as discussed above. In this embodiment, the outer connector body 1756 has a radially-outward flange 1784 located forwardly of the flange 1782 (which captures the forward end of the spring 1780). The flange 1784 has a trepan groove 1786 in its forward surface (a projection 1785 is located radially outward of the groove 1785). Also, at the rear end of the outer connector body 1756, there is greater clearance gap C between the outer connector body 1756 and the shell 1760 than in the assembly 1200 shown in FIGS. 1-4. The outer connector body 1716 of the connector 1710 has a beveled outer edge 1719 at its forward end 1718.

As shown in FIG. 5, during initial mating of the connectors 1710, 1750, the inner contact 1754 of the connector 1750 engages the inner contact 1712 of the connector 1710, which provides a first “centering” action of the connector 1750. This action also causes the spring 1780 to “bottom out.” As mating continues, the spring 1780 opens slightly, which causes the beveled outer edge 1719 of the outer connector body 1716 to contact the projection 1785. This interaction provides a second “centering” action to mating, which enables the clearance gap C between the rear portion of the outer connector body 1756 and the shell 1760 to be greater than in other embodiments.

Additional embodiments are disclosed and described in U.S. Patent Publication No. 2019/0312394 to Paynter, supra.

While the latch 885 shown in FIG. 3 can secure the ganged cable assemblies 1205, 1240 adequately, in some instances two different issues can arise. First, in fatigue testing (in which the assemblies 1205, 1204 are mated and latched 25 times), in some instances the latch 885 showed a tendency to deform. In addition, secure latching between the assemblies 1205, 1240 is needed in order to prevent the generation of passive intermodulation (PIM), which can develop between metal-to-metal surfaces that are not secured together tightly enough. PIM is undesirable and can affect the electrical performance of the connectors in the assemblies 1205, 1240.

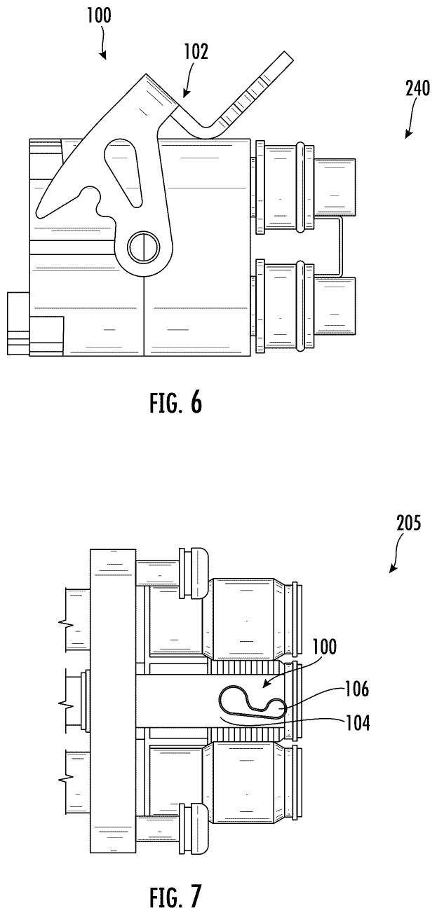

Referring now to FIGS. 6-8, a latching arrangement, designated broadly at 100, is shown therein. The latch arrangement includes a latch 102 (which is attached to one of the ganged connector assembly, such as the assembly 240 of FIG. 6) and a pair of posts 104 with capture projections 106 (which are attached to the mating ganged connector assembly, such as assembly 205 of FIG. 7). These components are discussed in greater detail below.

As can be seen in FIG. 8, the latch 102 has a main cross-member 110 and side walls 112 that extend downwardly from the ends of the cross-member 110. A tab 114 extends from one edge of the cross-member 110. Each of the side walls 112 is generally triangular, merges with the cross-member 110 at an upper end, and includes a pivot hole 116 at one lower end. A latching member 118 extends away from the opposite lower end. A generally semicircular first capture recess 120 is present at the base of the latching member 118. A second capture recess 122 is located on the lower edge of each side wall 112. An arcuate projection 126 is positioned between the first and second capture recesses 120, 122 and merges smoothly with them. A generally triangular aperture 128 is present in a central portion of each side wall 112.

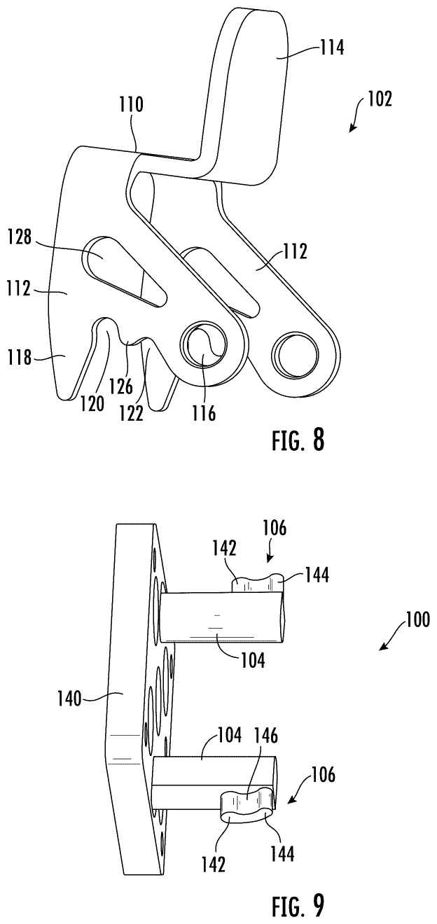

Referring now to FIG. 9, the posts 104 are mounted on and extend generally perpendicular to a mounting surface 140, such as the bulkhead of a piece of electronic equipment. Although not shown in FIG. 9, typically the coaxial connectors of a ganged connector assembly, such as the assembly 205, are mounted between the posts 104. Each capture projection 106 extends laterally from its respective posts 104 (i.e., the capture projections 106 extend away from each other in opposite directions). Each capture projection 106 is somewhat kidney-shaped (i.e., reniform) or dual-bulbed, with a larger bulb 142 at the end nearer the mounting surface and a smaller bulb 144 at the end farther from the mounting surface.

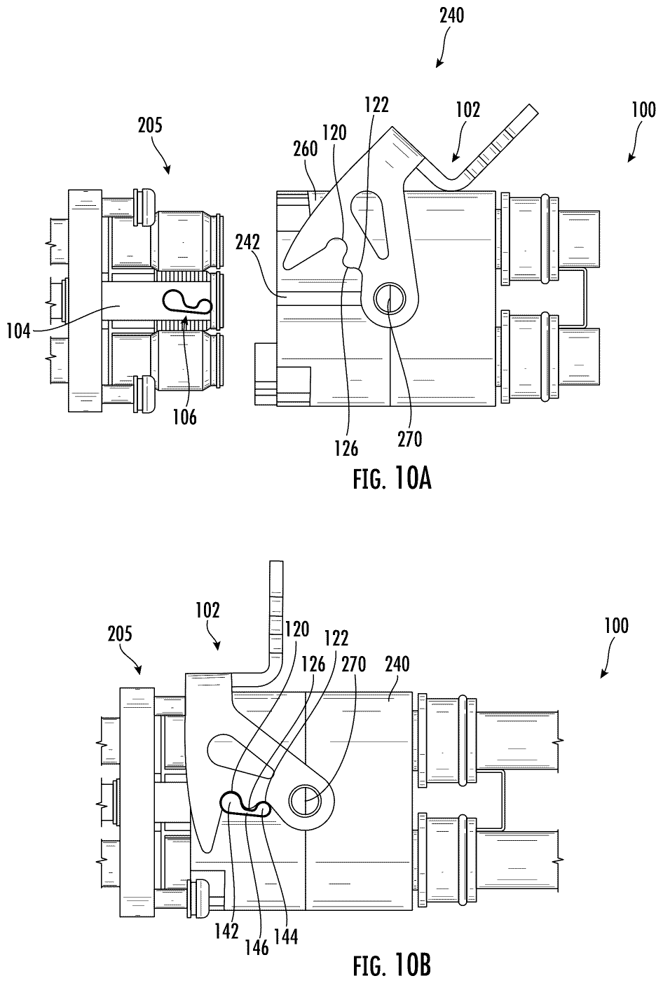

Referring now to FIGS. 10A and 10B, the mating of the assemblies 205, 240 is illustrated therein. In the unmated condition of FIG. 10A, the latch 102 is pivoted away from the free end of the assembly 240. In this position, the posts 104 of the assembly 205 can be inserted into slots 242 in the sides of the shell 260 of the assembly 240. Once the assemblies 205, 240 have been brought together, such that the coaxial connectors of the assembly 205 mate with the coaxial connectors of the assembly 240, the latch 102 can then be pivoted about its pivot point 270 to engage the projections 106 of the posts 104. More specifically, the first capture recess 120 of the latch 102 receives the larger bulb 142, and the second capture recess 122 receives the smaller bulb 144. The arcuate projection 126 is received in the space 146 between the bulbs 142, 144.

A latching arrangement such as that shown can improve the integrity of the mating when the assemblies are mated and latched. Because two different locking points are present (i.e., the larger bulb 142 within the first recess 120, and the smaller bulb 144 within the second recess 122), the latching arrangement can provide a “tighter,” more stable latched assembly pair. A more secure latch with less opportunity for slippage or the like can improve the PIM performance of the mated assemblies. In addition, the generally triangular shape of the side walls 112 provides a sturdier latch structure that is less prone to fracturing. Fracturing can also be reduced by including a generous radius at the intersection between the cross-member 110 and the side walls 112, and by shortening the length of the latching member 118.

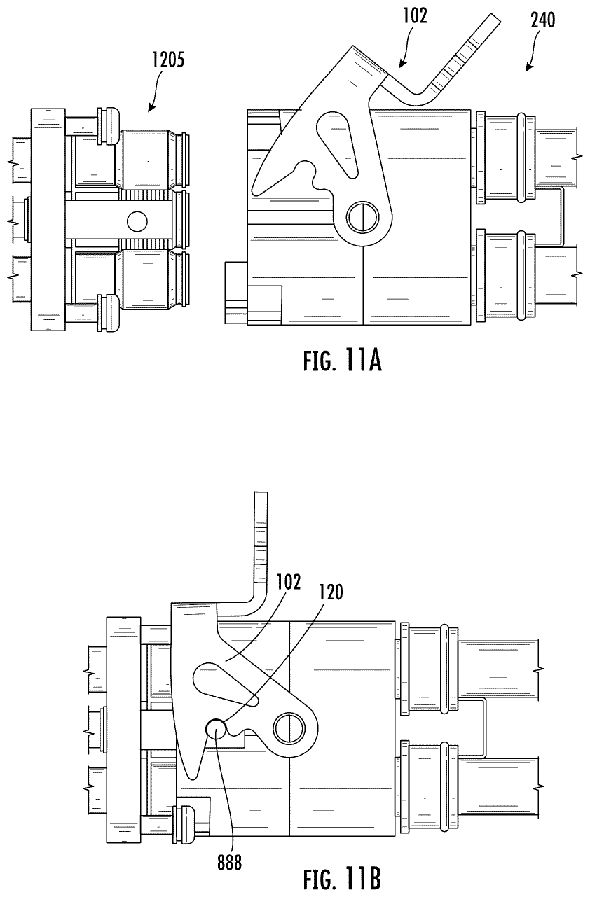

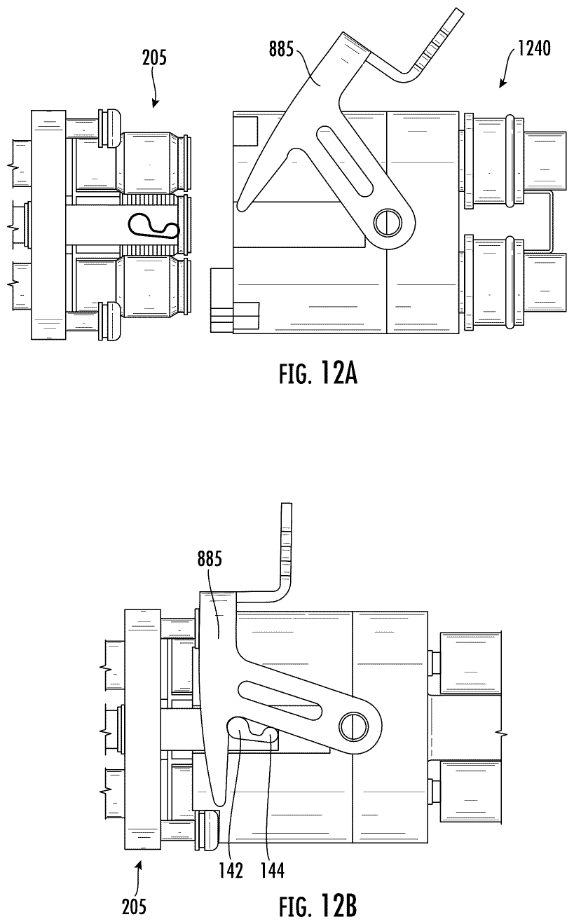

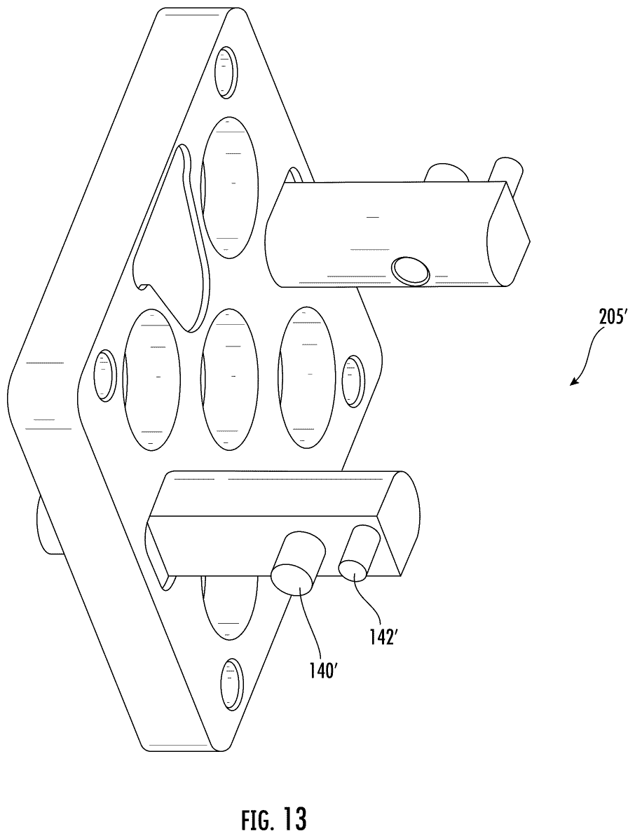

Another advantage of the latching arrangement can be seen in FIGS. 11A-12B. These figures illustrate that not only can the assemblies 205, 240 be used to mate with each other, they can also be used with existing equipment.that includes the prior assemblies 1205, 1240 discussed above. FIGS. 11A and 11B show how an assembly 240 that includes the latch 102 can be used with an assembly 1205. Such an assembly 1205 may be present in the field on a piece of existing equipment. FIG. 11B shows that the assembly 1205 can be mated with and latched to an assembly 240, with the post 888 of the assembly 1205 being received in the first recess 120.

Similarly, as shown in FIGS. 12A and 12B, the assembly 205 can be used with an existing assembly 1240. In that instance, the larger and smaller bulbs 142, 144 engage the single recess at the base of the latch 885.

Those of skill in this art will appreciate that the assemblies 205, 240 may take other forms. For example, although the assemblies 205, 240 include five coaxial connectors each in a cruciform pattern, other numbers of coaxial connectors (e.g., four) may also be employed. Further, other types of connectors (e.g., fiber optic connectors, hybrid connectors) that are suitable for “ganged” connectors may also be used.

As another example, the configurations of the projections 106 of the post 104 may differ (with corresponding configuration changes for the recesses in the latching member). For example, the bulbs 140, 142 may be the same size, or the larger and smaller bulbs may reverse positions. As another example, as shown in FIG. 13, the bulbs 140′, 142′ of the assembly 205′ may be separate structures (i.e., with a gap between them) rather than a single integrated structure. Other variations may also be possible.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

What is claimed is:

1. A mated ganged connector assembly, comprising:
a first connector assembly comprising a plurality of first coaxial connectors mounted on a substrate, each of the first coaxial connectors connected with a respective first coaxial cable, the first connector assembly further comprising a post extending from the mounting substrate, which first and second projections extend laterally from the post, and
a second connector assembly comprising a plurality of second coaxial connectors and a shell, each of the second coaxial connectors connected with a respective second coaxial cable, the shell defining a plurality of electrically isolated second cavities, each of the second coaxial connectors being located in a respective second cavity and mounted therein to float radially and axially relative to each of the other second coaxial connectors, wherein the second connector assembly includes a latch pivotable between an unlatched position and a latched position, the latch including a cross-member, side walls extending from the cross-member, and a latching member extending from each of the side walls, wherein first and second recesses are present in the latching member;
wherein in a mated condition each of the first coaxial connectors is mated with a respective second coaxial connector, and wherein the first and second connector assemblies are secured in the mated condition by the latch when the latch is in the latched position, the latch engaging the projection such that the first and second projections are received in the first and second recesses.

2. The assembly defined in claim 1, wherein an arcuate projection is present between the first and second recesses.

3. The assembly defined in claim 1, wherein the plurality of first coaxial connectors comprises four first coaxial connectors, and the plurality of second coaxial connectors comprises four second coaxial connectors.

4. The assembly defined in claim 1, wherein the plurality of first coaxial connectors comprises five first coaxial connectors, and the plurality of second coaxial connectors comprises five second coaxial connectors.

5. The assembly defined in claim 1, wherein the first and second projections are integrated as a dual-bulbed projection.

6. A connector assembly, comprising:
a plurality of coaxial connectors mounted on a substrate,
a plurality of coaxial cables, each of the coaxial connectors connected with a respective coaxial cable; and
a post extending from the mounting substrate, wherein first and second projections extend laterally from the post.

7. The assembly defined in claim 6, wherein the first and second projections are integrated as a dual-bulbed projection.

8. The assembly defined in claim 6, wherein the plurality of coaxial connectors comprises four coaxial connectors.

9. The assembly defined in claim 6, wherein the plurality of coaxial connectors comprises five first coaxial connectors in a cruciform pattern.

10. A coaxial connector assembly, comprising:
a plurality of coaxial connectors;
a plurality of coaxial cable, each connected with a respective coaxial connector;
a shell defining a plurality of electrically isolated cavities, each of the coaxial connectors being located in a respective second cavity and mounted therein to float radially and axially relative to each of the other coaxial connectors; and
a latch pivotable between an unlatched position and a latched position, the latch including a cross-member, side walls extending from the cross-member, and a latching member extending from each of the side walls, wherein first and second recesses are present in the latching member.

11. The assembly defined in claim 10, wherein the first and second projections are separated by an arcuate projection.

12. The assembly defined in claim 10, wherein the plurality of coaxial connectors comprises four coaxial connectors.

13. The assembly defined in claim 10, wherein the plurality of coaxial connectors comprises five coaxial connectors in a cruciform pattern.
